(19) United States
(12) Patent Application Publication
(10) Pub. No.: US 2006/0125689 A1
(43) Pub. Date: Jun. 15, 2006

(54) Interference cancellation in a receive diversity system

(76) Inventors: Anand P. Narayan, Boulder, CO (US); Eric S. Olson, Milwaukee, WI (US)

Correspondence Address: TENSORCOMM, INC., 1490 W. 121ST AVE., SUITE 105, WESTMINISTER, CO, 80234, US

(21) Appl. No.: 11/009,981

(22) Filed: Dec. 10, 2004

(51) Int. Cl. G01S 3/16

(52) U.S. Cl. 342/381; 342/384

(57) ABSTRACT

Systems and methods for employing substantial interference cancellation with a receive-diversity system are presented. A Coded Signal Processing Engine (“CSPE”) is communicatively coupled to each receiver chain of a receive-diversity system and is configured for substantially canceling one or more interfering signals from a digital baseband signal of one or more of the receiver chains. For example, either one receiver chain or a combination of receiver chains may be activated by the controller to process a signal. The CSPE may cancel interfering signals from the digital baseband signals of the activated receiver chains to generate one or more interference-canceled signals for each activated receiver chain. The interference-canceled signals may then be processed by processing fingers of the receiver chains and a controller may determine the number of receiver chains to keep active based on a signal parameter of the processed signal.

### BACKGROUND OF THE INVENTION

1. Field of the Invention

This invention generally relates to improving signal quality of a received signal. More specifically, the invention relates to providing substantial interference cancellation to a receiver system comprising receive diversity. As used herein, receive diversity refers to receiving a signal with a plurality of spatially separated antennas to improve signal quality. The embodiments shown and described herein may be particularly beneficial to systems employing Code Division Multiple Access (“CDMA”) signals, Wideband CDMA (“WCDMA”) signals, Broadband CDMA signals, Universal Mobile Telephone Service (“UMTS”) signals, Global Positioning System (“GPS”) signals and combinations thereof.

2. Discussion of the Related Art

Receive diversity increases the likelihood that at least one or a combination of a plurality of received signals will be of an acceptable processing quality. For example, a signal will typically travel along multiple paths and differentially arrive at an antenna. When multipath signals arrive at an antenna, the signals may cancel each other out since the superposition of signals may result in the well-known multipath-fading phenomenon. Through the implementation of spatially separated antennas, a signal received at one antenna may have better signal quality than the signal received at another antenna as it is unlikely that both antennas will simultaneously experience the same magnitude of multipath fading. Accordingly, the received signal with better quality or a weighted combination thereof may be selected for processing.

Rake receivers have been developed to take advantage of a plurality of multipath signals by time-aligning certain received signal paths from a plurality of antennas to counter the effects of multipath fading. The aligned signal paths are combined to improve the estimate of the received signal. For example, an estimate of the transmitted signal as it is received can be performed using a combination of a plurality of signal paths. This combination may be across a plurality of signal paths from a plurality of antennas. By combining multiple time-aligned paths, the probability that the signal is correctly received is increased because the signal paths may be combined constructively. Examples of such combining include Maximal Ratio Combining (“MRC”) and Minimum Mean Squared Error (“MMSE”).

Receive-diversity implementations often use multiple “receiver chains,” each having an antenna independently configured therewith. Each receiver chain comprises front-end receiver components, such as a low-noise amplifier, a passband filter, an RF down converter and an analog to digital (“A/D”) converter. Such components are known to those skilled in the art. The receiver chain of a rake receiver additionally comprises a plurality of processing fingers that process a digital received signal.

Each receiver chain may be used to form an independent estimate of the received signal. These independent receiver-chain estimates of the received signal may be combined to further improve the overall estimate of the received signal using one or more of the combining methods previously described. Alternatively, fingers associated with multiple antennas may be combined as typical rake-receiver fingers. While these receive-diversity implementations can improve signal estimation, the addition of separate receiver chains and/or fingers associated with separate antennas increases the overall power consumption of the receiver.

Since power consumption is often a concern, particularly for handsets, receive diversity is often controlled to minimize power consumption. For example, if one or more receiver chains generate data with a particular performance parameter (e.g., Signal to Noise Ratio, or “SNR”; Frame Error Rate, or “FER”; Bit Error Rate, or “BER”; etc.) that is better than a predetermined value, the receiver may either deactivate one or more receiver chains or discontinue switching between receiver chains associated with one or more antennas if receiver diversity is being used. However, if the receiver chain is providing data with an unacceptable performance parameter, the receiver may either allow switching between receiver chains or it may activate one or more receiver chains associated with one or more antennas.

One example of receive-diversity control within a rake receiver provides for deciding which receiver chain to use based on a comparison to a predetermined threshold. Similarly, receive-diversity control may provide for selecting the number of receive chains to use. For example, if the SNR of a selected signal (i.e., the energy of the selected signal E_{c} divided by the total power I₀ or E_{c}/I₀) for the combined signal of a plurality of receiver chains is greater than a predetermined SNR threshold, then the number of receiver chains may be decreased to conserve power. An SNR threshold may be chosen to produce an adequate BER for accurately recovering data. If, however, the SNR of the signal is below the threshold, receive-diversity combining may be initiated or the number of active receiver chains may be increased.

While receive diversity may improve certain signal parameters, it remains a goal to further improve these parameters because such improvements may lead to, among other things, increased capacity, increased data rates, greater signal coverage and decreased power requirements.

### SUMMARY OF THE INVENTION

In one embodiment of the invention, a receiver comprises a plurality of receiver chains. Each receiver chain is configured for receiving a radio signal. The controller may selectively activate or deactivate receiver chains by comparing signal parameters to signal-quality parameters or by other criteria (e.g., power consumption). If the receiver does not receive the signal at a required signal quality, the controller may select another receiver chain to receive the signal or increase the number of active receiver chains.

Each receiver chain comprises an A/D converter configured for converting a received RF signal to a digital baseband signal. A Coded Signal Processing Engine (“CSPE”) is communicatively coupled to each receiver chain and is configured for substantially canceling one or more interfering signals from a digital baseband signal of a receiver chain. For example, either one receiver chain or a combination of receiver chains may be activated by the controller to process a signal. The CSPE may cancel interfering signals from the digital baseband signals to generate one or more interference-canceled signals for each activated receiver chain.

In some embodiments of the invention, an interference matrix is generated from one or more interferers. A cancellation operator, such as a projection operator, is generated from the interference matrix and applied to each received signal to cancel one or more interfering signals. The projection operator may have substantially the following form:
Pₛ^{⊥}I−S(S^{T}S)⁻¹S^{T},
where Pₛ^{⊥} is the projection operator, I is an identity matrix, S is an interference matrix and S^{T} is a transpose of S. Following cancellation, the plurality of received signals from the plurality of receive chains may be combined. Any of the well-known combining algorithms may be employed, including (but not limited to) a Maximal Ratio Combining algorithm or a Minimum Mean Squared Error algorithm.

These and other embodiments of the invention are described with respect to the figures and in the following description of the preferred embodiments.

### BRIEF DESCRIPTION OF THE DRAWINGS

FIG. 1 is a block diagram of a receive-diversity system configured with a CSPE in one exemplary embodiment of the invention.

FIG. 2 is a block diagram of a CSPE in one exemplary embodiment of the invention.

FIG. 3 is a block diagram of a receive-diversity system configured with the CSPE of FIG. 2 in one exemplary embodiment of the invention.

FIG. 4 is a block diagram of an exemplary receiver chain configured with the CSPE of FIG. 2 in one embodiment of the invention.

FIG. 5 is a block diagram of a CSPE with a plurality of matrix generators and configured with a receiver chain, such as the receiver chain of FIG. 4 in one exemplary embodiment of the invention.

FIG. 6 is a flowchart of one exemplary method embodiment of the invention.

### DETAILED DESCRIPTION OF THE DRAWINGS

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

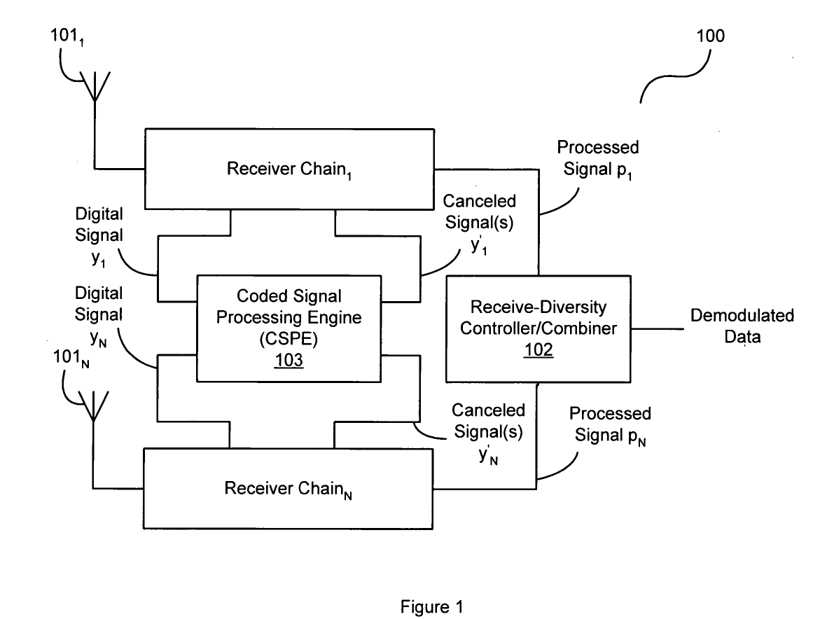

FIG. 1 is a block diagram of a receive-diversity system 100 representing an exemplary embodiment of the invention. In this embodiment, a CSPE 103 selectively cancels one or more interfering signals received by one or more receiver chains_{1 . . . N} of receive-diversity system 100. Receive-diversity system 100 comprises receive-diversity controller/combiner 102 for controlling the number of receiver chains_{1 . . . N} used to receive a signal (i.e., via respective antennas 101₁ . . . 101_{N}) and for the combination of processed signals_{1 . . . N}. For example, each receiver chain_{1 . . . N} is configured for receiving a radio signal when activated by controller/combiner 102. Controller/combiner 102 controls which receiver chain or which combination of receiver chains_{1 . . . N} receives the radio signal by comparing the received signal parameters to one or more signal-quality parameters (e.g., BER, FER and SNR) and/or by other criteria (e.g., power consumption).

The received radio signal comprises a signal of interest (“SOI”) and typically one or more interfering signals, such as cross-channel interference and/or co-channel interference. Co-channel interference may include multipath interference from the same transmitter, wherein a transmitted signal takes unique paths that causes one path (e.g., an interfering signal path) and another path containing an SOI to differentially arrive at a receiver, thereby hindering reception of the SOI. Cross-channel interference includes interference caused by signal paths from other transmitters that hinder the reception of the path containing the SOI. Cross-channel interference may also include multipath interference from the other transmitters. Such interference can degrade an SOI when it is present in any substantial form.

Controller/combiner 102 may selectively activate or deactivate one or more of the receiver chains_{1 . . . N} to improve signal quality of an SOI. For example, if receiver chain₁ does not receive the SOI at the required signal quality, controller/combiner 102 may select receiver chain_{N} to receive the signal or increase the number of active receiver chains_{1 . . . N} within receive-diversity system 100. Contrarily, if receive-diversity system 100 receives the SOI at the required signal quality, controller/combiner 102 may deactivate receive diversity or decrease the number of active receiver chains within the receive-diversity system 100 because receiver diversity may not be required.

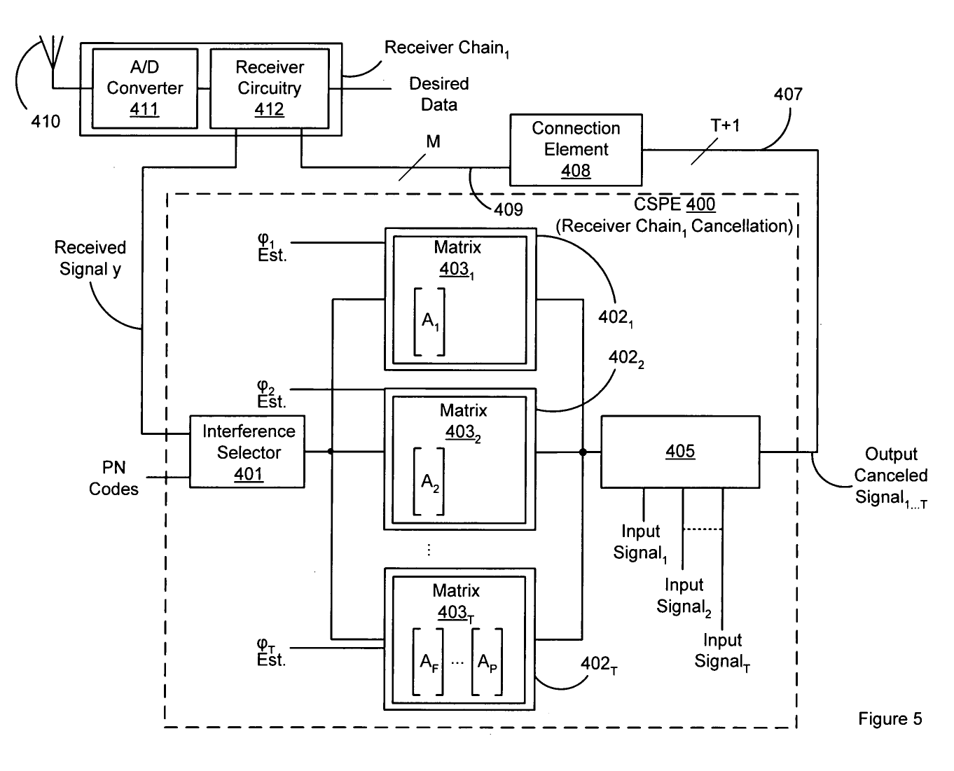

Each receiver chain comprises an A/D converter (e.g., as shown in FIG. 5) for converting a received RF signal to a digital baseband signal. The CSPE 103 is communicatively coupled to each receiver chain_{1 . . . N} and is configured for substantially canceling one or more interfering signals from a digital baseband signal of a receiver chain. For example, either one receiver chain_{1 . . . N} or a combination of receiver chains_{1 . . . N} may be directed by the controller/combiner 102 to process an SOI. The CSPE 103 may substantially cancel interfering signals from a digital baseband signal of any given receiver chain as determined by the controller/combiner 102 in order to generate a substantially interference-canceled signal for that receiver chain_{1 . . . N}. For example, receiver chain₁ transfers a digital baseband signal y₁ to the CSPE 103, which performs one or more interference-cancellation operations on the digital signal y₁ to generate one or more substantially interference-canceled signals y′₁. The CSPE 103 transfers the interference-canceled signals y′₁ to the receiver chain₁ for processing, which may include tracking and demodulation of the interference-canceled signals y′₁.

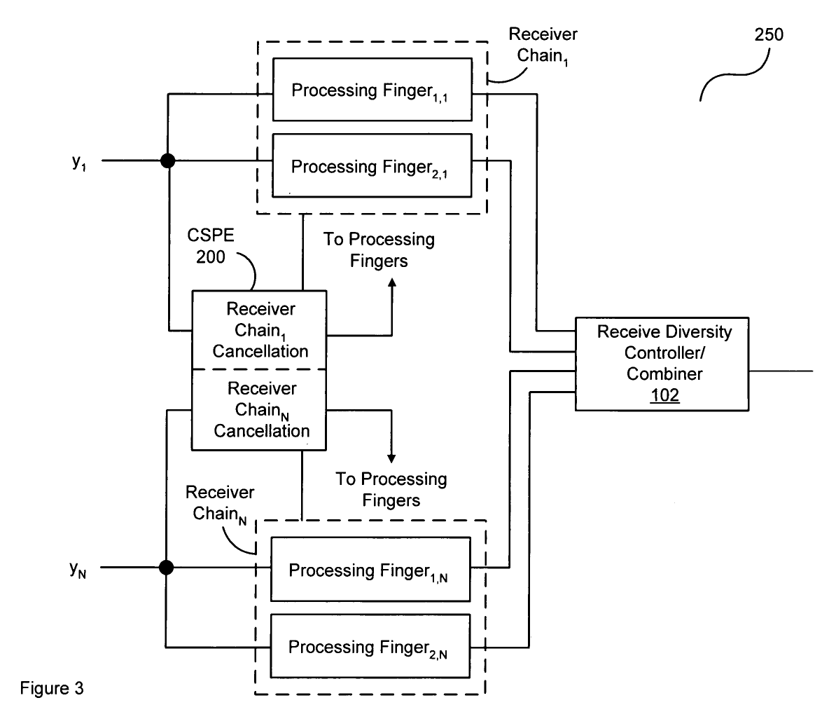

In one embodiment of the invention, receiver chains_{1 . . . N} comprise rake receivers having a plurality of processing fingers, wherein each processing finger is configured for tracking and demodulating a signal path (e.g., a path comprising the SOI within the interference-canceled signal). Such an embodiment is shown and described with respect to FIG. 3. Although discussed with respect to a single receiver chain, those skilled in the art should recognize that the other receiver chains within the receive-diversity system 100 may operate similarly and that the present description is only intended as an example.

The controller/combiner 102 is also configured for receiving one or more processed interference-canceled signals p_{1 . . . N} from one or more of the receiver chains_{1 . . . N} and combining the signals to provide an estimate of the originally transmitted signal. For example, the controller/combiner 102 may receive a processed interference-canceled signal p₁ (i.e., the signal comprising the SOI) from receiver chain₁ and a processed interference-canceled signal p_{N} from receiver chain_{N} and then combine the signals p₁ and p_{N} using a well known combining method, such as MRC or MMSE.

Based on the estimate of the combined signal, the controller/combiner 102 controls the number of receiver chains used to receive the SOI. For example, the controller/combiner 102 may compare the combined SOI processed by one or more receiver chains_{1 . . . N} to a predetermined threshold to control the number of receiver chains_{1 . . . N} used. This comparison may comprise comparing the SOI to a predetermined level of SNR, BER, and/or FER that has been deemed acceptable for accurately recovering data within the SOI.

While one exemplary preferred embodiment has been shown described herein, those skilled in the art should recognize that the invention is not intended to be limited to the preferred embodiment. Rather, the invention is only intended to be limited by the language recited in the claims and equivalents. Further, those skilled in the art should recognize that certain components of the received diversity system 100 may be implemented in hardware, software, firmware or combinations thereof. For example, components of CSPE 103 may be implemented in hardware as an Application Specific Integrated Circuit (“ASIC”), a Field Programmable Gate Array (“FPGA”), a general-purpose computer processor and/or other custom circuitry. Some components of CSPE 103 may be implemented in software, such as C, C++, Java and/or processor specific machine and/or assembly languages.

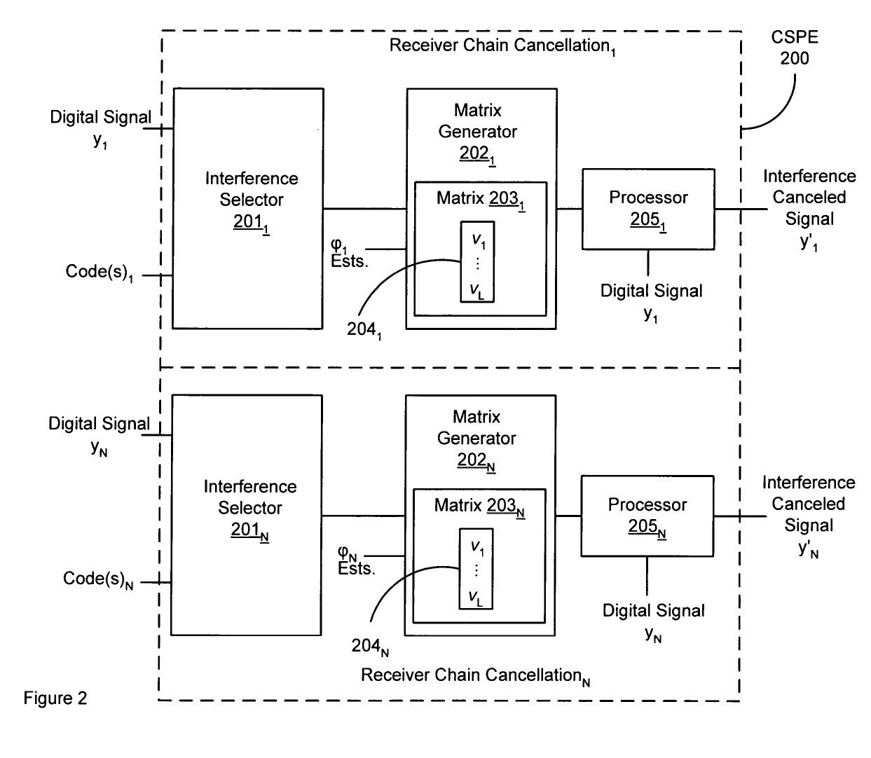

FIG. 2 is a block diagram of a CSPE 200 according to one exemplary embodiment of the invention. In this embodiment, the CSPE 200 is configured for operating with a plurality a receiver chains_{1 . . . N} to substantially cancel one or more interfering signals from digital signals of the receiver chains (e.g., digital signal y₁ of receiver chain₁ and digital signal y_{N} of receiver chain_{N} shown in FIG. 1).

The CSPE 200 comprises a plurality of interference selectors 201_{1 . . . N} wherein each interference selector 201_{1 . . . N} is configured for receiving a digital signal y (labeled Digital Signal y_{1 . . . N}) from a corresponding receiver chain (not shown). The interference selectors 201_{1 . . . N} are configured for selecting one or more interfering signals from the digital signal y for substantial cancellation. For example, the interfering signals may comprise codes used in communications systems, such as CDMA systems, Broadband CDMA systems, UMTS systems and/or GPS systems. These codes may include pseudorandom noise (“PN”) codes, Walsh codes and/or Quasi-Orthogonal Function (“QOF”) codes.

Once the interference selectors 201_{1 . . . N} select the interfering signals for cancellation, code components of the signals are transferred to corresponding matrix generators 202_{1 . . . N}, wherein each matrix generator 202_{1 . . . N} generates an interference matrix (labeled 203_{1 . . . N}). For example, the interference selector 201₁ may transfer codes of one or more interfering signals comprised within digital signal y₁ to matrix generator 202₁ for generating interference matrix 203₁. Examples of matrix generation are described in the U.S. patent application Ser. No. 10/935,015, which is incorporated by reference. These codes may form vectors 204 such that each vector comprises code components of one or more interfering signals selected by the associated interference selector 201. In one embodiment, matrix generators 202_{1 . . . N} also receive phase estimates (labeled φ_{1 . . . N} Ests.) of the interfering signals. The phase estimates are applied onto associated interfering-signal vectors.

The generated matrices 203_{1 . . . N} are transferred to corresponding processors 205_{1 . . . N} for generation of the interference-canceled signals y′_{1 . . . N}. For example, each processor 205 may generate a cancellation operator which is applied to an input signal (e.g., digital signal y₁) to substantially cancel the selected one or more interfering signals from the input signal and thereby generate the interference-canceled signal y′₁. In one embodiment of the invention, the cancellation operator is a projection operator that projects the digital signal y₁ onto a subspace that is substantially orthogonal to the selected interfering signals. A projection operator may be generated with respect to the following form:
Pₛ^{⊥}=I−S(S^{T}S)⁻¹S^{T}, (Eq. 1)
wherein Pₛ^{⊥} is the projection operator, I is an identity matrix, S is the interference matrix and S^{T} is a transpose of S. Examples of such interference-cancellation methods and the associated cancellation operators are described in U.S. patent application Ser. Nos. 10/935,669 and 10/935,015, and a filed U.S. patent application entitled “Systems and Methods for Serial Cancellation” (TCOM0024), which are incorporated by reference.

As illustrated in this embodiment, the CSPE 200 is configured for performing interference cancellations for associated activated receiver chains. For example, the CSPE 200 is shown with interference-cancellation processing performed by components 201₁, 202₁ and 205₁ of the associated receiver chain cancellation₁ shown in FIG. 2. Similarly, the CSPE 200 is shown with interference-cancellation processing performed by components 201_{N}, 202_{N} and 205_{N} of the associated receiver chain cancellation_{N} also shown in FIG. 2. Accordingly, interference cancellation may be independently controlled and performed for a receiver chain based on control from a controller/combiner, such as the controller/combiner 102 shown in FIG. 1.

Although illustrated with components that perform a single interference cancellation for a given receiver chain, those skilled in the art should readily recognize that a plurality of interference cancellations may be performed for any given receiver chain. For example, the Ser. No. 10/935,669 and TCOM0024 applications show and describe embodiments comprising a plurality of interference cancellations performed both in parallel and in serial, respectively. Accordingly, those skilled in the art should recognize that the present invention is not intended to be limited to the interference-cancellation modes exemplarily shown and described herein. Rather, the scope of the invention is expressed by the language recited in the claims and equivalents.

FIG. 3 is a block diagram illustrating a receive-diversity system 250 in one exemplary embodiment of the invention configured with the CSPE 200 shown in FIG. 2. The CSPE 200, as shown herein, is configured for performing independent interference cancellations for a plurality of receiver chains_{1 . . . N}. For example, the controller/combiner 102 may determine which of the receiver chains_{1 . . . N} is to receive a radio signal and generate a digital signal (i.e., corresponding digital signals y_{1 . . . N}) therefrom. As described in the exemplary embodiments herein, CSPE 200 may subsequently perform interference cancellation on the digital signal y of the activated receiver chains_{1 . . . N}. Interference cancellation for a given receiver chain may result in a plurality of interference-canceled signals being generated and transferred to processing fingers of that receiver chain.

As shown herein, each receiver chain_{1 . . . N} is configured with a plurality of receiver processing fingers (e.g., receiver chain₁ comprising processing fingers_{1,1 . . . 2,1} and receiver chain_{N} comprising processing fingers_{1,N . . . 2,N} wherein the first number denotes the number of the processing finger and the second number denotes the number of the receiver processing fingers_{1 . . . N}), such as those found in a rake receiver. Each receiver chain_{1 . . . N} is controlled by the controller/combiner 102 for processing a digital signal (i.e., y₁ . . . y_{N}) generated by that receiver chain_{1 . . . N}. For example, the controller/combiner 102 may direct one or more of the receiver chains_{1 . . . N} to receive a radio signal and convert that signal to a digital signal. The digital signal may be processed by one or more of the processing fingers of the receiver chain in addition to having interference cancellation performed thereon by the CSPE 200.

The CSPE 200 may be communicatively coupled to the receiver chains_{1 . . . N} to receive codes, such as those described herein, and/or phase estimates from the processing fingers to assist in the generation of interference matrices for an activated receiver chain. For example, when the controller/combiner 102 activates a particular receiver chain, the portion of the CSPE 200 dedicated to that particular receiver chain may generate an interference matrix based on the codes and phase estimates of selected interfering signals. The CSPE 200 may then generate one or more interference-canceled signals and subsequently transfers those signals to one or more processing fingers of the receiver chain. The processing fingers may, in turn, track and demodulate the interference-canceled signals (i.e., recovering the SOI substantially without the degrading effects of the signals selected for interference cancellation).

An activated receiver chain transfers one or more processed (e.g., tracked and demodulated) signals to the controller/combiner 102 for estimation of an SOI as it was transmitted. The controller/combiner 102 may combine processed signals from the processing fingers using one or more combining methods, such as those described herein, and compare the combined signal to a predetermined threshold to determine if the signal will provide acceptable accuracy for recovery of the underlying SOI data. Assuming there are multiple activated receiver chains, the controller/combiner 102 may combine processed signals of the activated receiver chains and compare a signal parameter of the combined signal to the predetermined threshold.

Based on the accuracy of the recovered SOI data, the controller/combiner 102 may adapt the number of receiver chains used to receive the SOI. For example, if the signal parameter of a signal combined from a plurality of receiver chains exceeds a predetermined threshold, the controller/combiner 102 may deactivate one or more of the receiver chains within the receive-diversity system 250 to conserve power. Alternatively, if the signal parameter of the signal is below the predetermined threshold, the controller/combiner 102 may activate one or more receiver chains within the receive-diversity system 250.

The embodiment described and shown herein may provide certain advantages to a mobile handset receiver employing receive diversity without interference cancellation. For example, interference cancellation performed by the CSPE 200 may improve the SNR of an SOI, and therefore, certain other signal parameters, such as BER and FER. Accordingly, the CSPE 200 may decrease the reliance upon receive diversity or, alternatively, complement the receive-diversity system such that a carrier's user capacity can be increased.

Those skilled in the art should recognize that the receive-diversity system 250 is not intended to be limited to the number of receiver chains or the number of processing fingers shown and described herein. For example, the number of receiver chains implemented within the receive-diversity system 250 may be a matter of design choice. Such design choice considerations may include, for example, determining a practical number of antennas for a given receiver based on the receiver size and/or received signal frequency. Additionally, the number of processing fingers implemented within each receiver chain may be a matter of design choice. Exemplary receiver chains include rake receivers comprising between two and six processing fingers. However, the invention is not intended to be limited to the embodiments shown and described herein; rather, the invention should only be limited to the language recited in the claims and their equivalents.

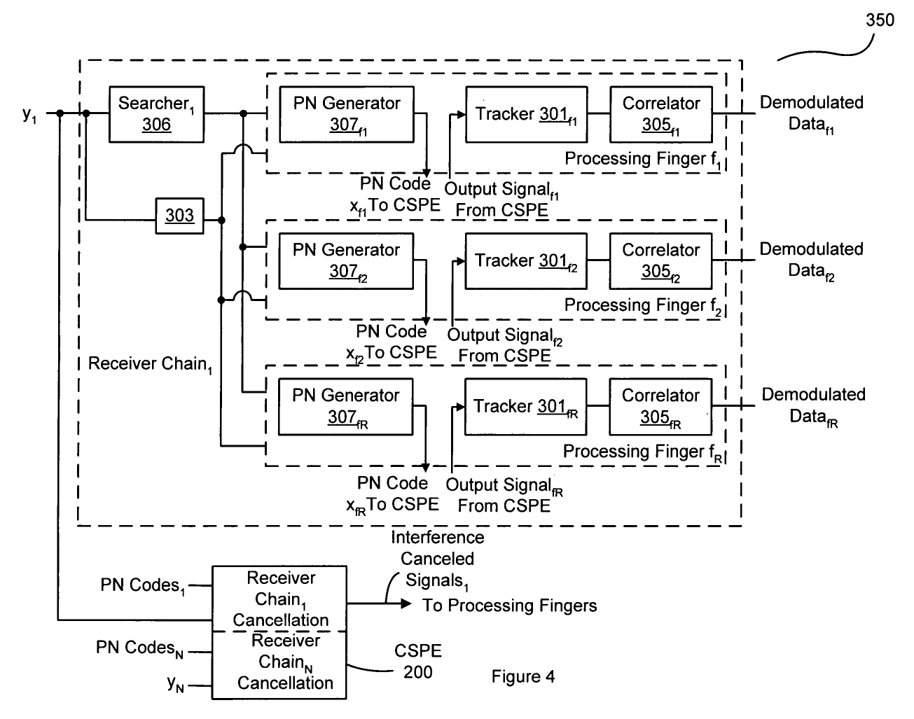

FIG. 4 is a block diagram illustrating an exemplary embodiment of the invention in which a receiver chain₁ is configured with the CSPE 200 of FIG. 2. In this embodiment, receiver chain₁ is a rake receiver 350 comprising a searcher finger 306 and a plurality of processing fingers (labeled processing fingers f₁ . . . f_{R}). The CSPE 200 is configured with receiver chain₁ for substantially canceling one or more interfering signals from a digital signal y₁.

Searcher finger 306 is configured for searching for a signal path comprising an SOI and comprised with digital signal y₁ and transferring the signal path to the processing fingers f₁ . . . f_{R}. In the processing fingers f₁ . . . f_{R}, PN generators 307_{f1 . . . fR} generate PN codes_{1 . . . N} of the interfering signal path. PN generators 307 _{f1 . . . fR} transfer the PN codes x_{f1} . . . x_{fR} of the interfering signals to the CSPE 200 to construct interference matrices, such as matrices 403 shown and described with respect to FIG. 5. The CSPE 200 thereby generates the interference-canceled signals by substantially canceling the interfering signals from the digital signal y₁, as described herein. The CSPE 200 transfers the interference-canceled signals to the processing fingers f1 . . . fR for subsequent tracking and demodulation of the SOI by trackers 301_{f1 . . . fR} and correlators_{f1 . . . fR}, respectively. The outputs of the processing fingers f₁ . . . f_{R} comprise demodulated data (labeled Demodulated Data_{f1 . . . fR}) which can be combined, for example, by the controller/combiner 102 shown in FIG. 3.

A delay element 303 is configured for delaying the digital signal y₁ to the processing fingers f₁ . . . f_{R}. The delay introduced by delay element 303 may be used to compensate the signal y₁ for the delay introduced by the CSPE 200. Cancellation processing introduces a delay (e.g., 3 symbols). Thus, in order for the tracker 301 to track the same portion of data (whether the data is canceled or uncanceled), the delay must be introduced.

While one embodiment is shown and described herein, those skilled in the art should recognize that other embodiments fall within the scope and spirit of the invention. For example, the number of processing fingers shown and described in the rake receiver 350 may vary as a matter of design choice. Rake receivers are well known to those skilled in the art and their implementations may vary. Accordingly, the invention is not intended to be limited to the exemplary embodiment shown and described herein. Rather, the invention should only be limited to the language recited in the claims and their equivalents.

FIG. 5 is a block diagram of a CSPE 400 with a plurality of matrix generators 403_{1 . . . T} and configured with a receiver chain, such as receiver chain₁ of FIG. 4, in one exemplary embodiment of the invention. Receiver chain₁ comprises an antenna 101₁ configured for receiving a radio signal and an A/D converter configured for converting the radio signal to a digital baseband signal. The digital baseband signal is transferred to receiver circuitry 412₁ for subsequent transfer to the CSPE 400 for receiver chain₁ interference cancellation.

In this embodiment, the CSPE 400 (Receiver Chain₁ Cancellation) is configured for performing a plurality of interference cancellation operations on a respective plurality of input signals_{1 . . . T} in accordance with the interference-cancellation techniques described herein. For example, an interference selector 401 may be configured for receiving a digital signal y₁ from the receiver chain₁ and PN codes of one or more interfering signals selected for cancellation. The selected interfering signals are formed as sub-matrices (labeled A₁, A₂, . . . A_{F} . . . A_{P}) by matrix generators 402_{1 . . . T} within the interference matrices 403_{1 . . . T}. A processor 405 uses the interference matrices 403_{1 . . . T} to substantially cancel selected interfering signals from a plurality of input signals_{1 . . . T} associated with the matrices 403_{1 . . . T}.

The interference-canceled signals_{1 . . . T} resulting from the interference cancellations performed by the processor 405 are transferred back to receiver circuitry 412 corresponding to receiver chain₁ to recover desired data from a substantially interference-cancelled signal. In one embodiment, a T+1-channel transfer path 407 is configured for transferring the interference-canceled signals and uncanceled signal y₁ and the digital signal y₁, to a connection element 408. The connection element 408 is configured for transferring one or more signals via an M-channel transfer path 409 to the receiver circuitry 412. For example, connection element 408 may be a communication switch or multiplexer configured for receiving T+1 signals from T+1 channels of one device and selectively transferring M signals to M channels of another device.

Receiver circuitry 412 may comprise a rake receiver, such as the rake receiver 350 shown in FIG. 4. Accordingly, receiver circuitry 412 may comprise a plurality of processing fingers, such as processing fingers f₁ . . . f_{R} shown in FIG. 4. Each processing finger is configured for tracking and demodulating an SOI of an interference-canceled signal or the SOI of the uncanceled digital signal y₁ to produce a data signal. Data from the SOI may be transferred to a controller/combiner (such as the controller/combiner 102 in FIG. 3) for combining the data with other receiver chains and/or determining a number of receiver chains to use within the receive-diversity system, as described herein.

Exemplary embodiments of the CSPE 400 are shown and described in the Ser. No. 10/935,669 and TCOM0024 applications, which are incorporated by reference. Such embodiments may include techniques for performing either serial or parallel interference cancellation. Those skilled in the art should recognize that such embodiments may be configured with a receiver chain as shown and described herein. Additionally, those skilled in the art should recognize that the invention is not intended to be limited to the exemplary embodiment shown and described herein. Rather, the scope of the invention is intended to be defined by the claims and their equivalents.

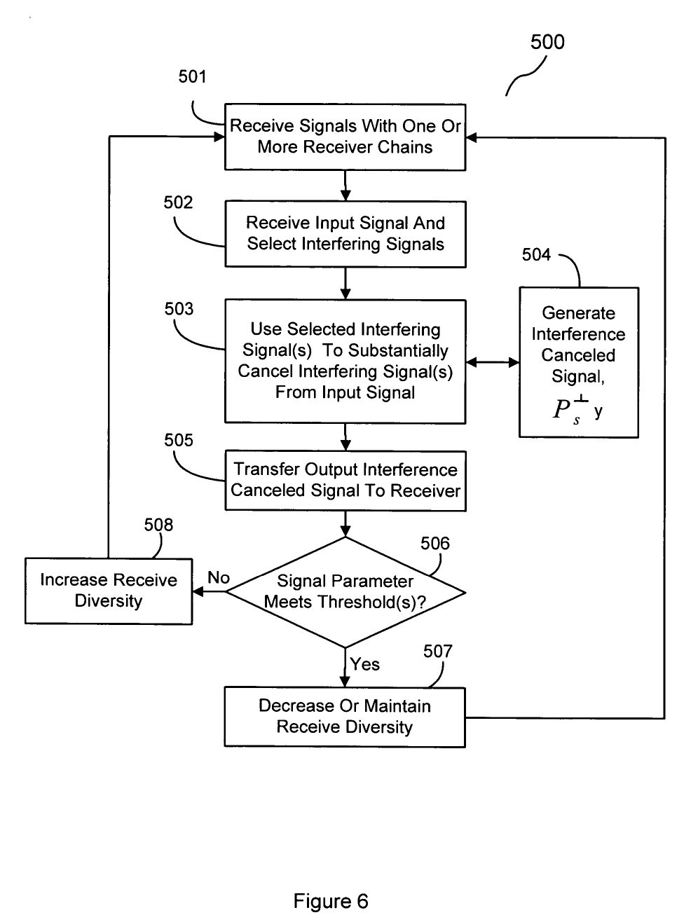

FIG. 6 is a flowchart 500 of an exemplary method embodiment of the invention. In this embodiment, a plurality of signals is initially received 501 by one or more receiver chains, such as receiver chain₁ shown in FIG. 1. An input signal and selected interfering signals are received 502 to initiate interference cancellation upon the input signal. For example, the input signal may be a digital signal converted from a radio signal received by a receiver chain. The input signal may comprise an SOI and one or more interfering signals. Accordingly, the interfering signals may be selected from the input signal. The interfering signals selected for cancellation are used to substantially cancel 503 the interfering signals from the input signal.

In one embodiment of the invention a CSPE, such as the CSPE 103 shown in FIG. 1, uses the input signal and the selected interfering signals to generate an interference-canceled signal 504 comprising the form Pₛ^{⊥}y. The term Pₛ^{⊥} is a projection operator configured for projecting the input signal onto a subspace that is substantially orthogonal to the interfering signals in the digital signal y. For example, the digital signal y, whereupon the projection is computed, may comprise one or more interfering signals and an SOI. Accordingly, the projection of the digital signal substantially cancels the interfering signals from the input signal to generate a substantially interference-canceled digital signal. In one embodiment of the invention, a plurality of interference-canceled signals is generated.

Once the one or more interference-canceled signals are generated, the signals are transferred 505 to a receiver for further processing. For example, the CSPE may transfer a plurality of interference-canceled signals to a plurality of processing fingers within a rake receiver of a receiver chain. Processed signals (e.g., tracked and demodulated signals) from the processing fingers and/or processed signals from other receiver chains may be combined. A signal parameter of the combined signal may be compared 506 to one or more predetermined thresholds. For example, the signal parameter may comprise an SNR, a BER and/or an FER of the signal that is compared to a predetermined SNR, BER and/or FER threshold. This comparison is performed to determine if the combined signal provides an acceptable accuracy for data recovery of the SOI.

If the signal parameter does not meet or exceed the threshold(s), then the receive diversity may be increased 508 via activation of one or more receiver chains. Alternatively, receive diversity may be switched by deactivating a presently activated receiver chain and activating another. In either case, the process of receiving 501 a signal is repeated. However, if the signal parameter does meet or exceed the threshold(s), receive diversity may either be maintained or decreased 507 (e.g., via deactivating one or more receiver chains). Again, the process returns to receiving 501 a signal.

Embodiments disclosed herein may improve receive-diversity systems through the implementation of interference cancellation. For example, a CSPE, as described and illustrated herein, may substantially cancel one or more signals interfering with an SOI and accordingly improve the SNR of the SOI. Receive-diversity systems also seek to improve the SNR of an SOI via selective activation of one or more receiver chains. Accordingly, improving the SNR of an SOI with interference cancellation can reduce reliance on receive diversity for enhancing the SOI data recovery. Further benefits of various embodiments include increased user capacity, increased data rates, greater signal coverage and reduced power requirements.

Moreover, the embodiments disclosed herein may be implemented in a variety of ways. For example, certain components of the receive-diversity embodiments herein may be implemented in hardware, software, firmware or combinations thereof. For example, components of a CSPE may be implemented in hardware as an Application Specific Integrated Circuit (“ASIC”), a Field Programmable Gate Array (“FPGA”), a general-purpose computer processor and/or other custom circuitry. Some components of the CSPE embodiments disclosed herein may be implemented in software, such as C, C++, Java and/or processor-specific machine and/or assembly languages. For at least these reasons, the scope of the invention should be defined by language recited in the claims and their equivalents.

While the invention has been illustrated and described in detail in the drawings and foregoing description, such illustrations and descriptions are merely exemplary, and should not be interpreted as restricting the invention. Accordingly, it should be understood that only the preferred embodiment and minor variants thereof have been shown and described, and that all changes and modifications that are encompassed within the spirit of the invention are desired to be protected.

What is claimed is:

1. A receive-diversity system, comprising:
a plurality of receiver chains;
a controller communicatively coupled to the receiver chains and configured for selecting one or more of the receiver chains to process a received signal; and
a processing engine communicatively coupled to the receiver chains and configured for substantially canceling one or more interferers from the received signal.

2. The receive-diversity system of claim 1, wherein the received signal comprises a plurality of communication signals selected from a group consisting of Code Division Multiple Access signals, Wideband Code Division Multiple Access signals, Global Positioning System signals, and Universal Mobile Telephone Service signals.

3. The receive-diversity system of claim 1, wherein at least one receiver chain comprises a plurality of processing fingers and wherein at least one of the plurality of processing fingers is configured for processing an interference-canceled signal.

4. The receive-diversity system of claim 3, wherein the controller is configured for combining processed signals from the plurality of processing fingers.

5. The receive-diversity system of claim 1, wherein the controller is configured for combining a processed signal from each of the plurality of receiver chains.

6. The receive-diversity system of claim 1, wherein the processing engine comprises a matrix generator configured for generating an interference matrix from at least one of the one or more interferers in a digital signal from one of the plurality of receiver chains.

7. The receive-diversity system of claim 6, wherein the processing engine comprises a processor configured for generating a cancellation operator from the interference matrix.

8. The receive-diversity system of claim 7, wherein the cancellation operator is a projection operator substantially comprising the form:
Pₛ^{⊥}=I−S(S^{T}S)⁻¹S^{T},
where Pₛ^{⊥} is the projection operator, I is an identity matrix, S is the interference matrix and S^{T} is a transpose of S.

9. The receive-diversity system of claim 8, wherein the projection operator is configured for projecting a received signal onto a subspace substantially orthogonal to at least one interfering signal.

10. The receive-diversity system of claim 1, wherein the controller is further configured for comparing a signal parameter to a predetermined threshold to control a number of the plurality of receiver chains.

11. The receive-diversity system of claim 10, wherein the signal parameter is selected from a group consisting of Signal to Noise Ratio, Frame Error Rate, and Bit Error Rate.

12. A method, comprising:
providing for receiving a signal with a first receiver chain;
providing for substantially canceling one or more interferers from the signal;
providing for selecting either a second receiver chain or a combination of the first receiver chain and the second receiver chain to receive the signal based on a signal parameter.

13. The method of claim 12, wherein providing for selecting either the second receiver chain or the combination of the first receiver chain and the second receiver chain comprises providing for comparing the signal parameter to a predetermined value.

14. The method of claim 13, wherein the signal parameter is selected from a group consisting of Signal to Noise Ratio, Frame Error Rate, and Bit Error Rate.

15. The method of claim 12, wherein providing for substantially canceling the one or more interferers comprises providing for generating an interference matrix from the one or more interferers.

16. The method of claim 15, wherein providing for substantially canceling the one or more interferers further comprises providing for generating a cancellation operator from the interference matrix.

17. The method of claim 16, wherein providing for generating the cancellation operator comprises providing for generating a projection operator substantially according to the following form:
Pₛ^{⊥}=I−S(S^{T}S)⁻¹S^{T},
where Pₛ^{⊥} is the projection operator, I is an identity matrix, S is an interference matrix and S^{T} is a transpose of S.

18. The method of claim 16, wherein providing for substantially canceling the one or more interferers further comprises providing for applying the cancellation operator to the signal to substantially cancel the one or more interferers from the signal.

19. The method of claim 17, wherein providing for substantially canceling the one or more interferers further comprises providing for applying the projection operator to the signal to substantially cancel the one or more interferers from the signal.

20. The method of claim 12, further comprising providing for combining a first processed signal of the first receiver chain and a second processed signal of the second receiver chain to improve processing of the signal, wherein the first processed signal and the second processed signal are correlated signals of a signal of interest.

21. The method of claim 20, wherein providing for combining the first processed signal and the second processed signal comprises providing for combining using a Maximal Ratio Combining algorithm or a Minimum Mean Squared Error algorithm.

22. The method of claim 12, further comprising providing for combining processed signals from processing fingers of at least one receiver chain, wherein the processed signals are digital representations of a correlated signal of interest of the at least one receiver chain.

23. The method of claim 21, wherein providing for combining the processed signals comprises providing for combining using a Maximal Ratio Combining algorithm or a Minimum Mean Squared Error algorithm.

24. A digital computer system programmed to perform the method of claim 12.

25. A computer-readable medium storing a computer program implementing the method of claim 12.

26. A method, comprising:
providing for receiving a signal with at least one of a plurality of receiver chains;
providing for substantially canceling one or more interferers from the signal; and
providing for comparing a signal parameter of the signal to a predetermined threshold to control use of the receiver chains.

27. The method of claim 26, further comprising providing for selecting either a first receiver chain or a combination of the first receiver chain and a second receiver chain to process the signal.

28. The method of claim 27 further comprising providing for selecting based on the signal parameter from a group consisting of Signal to Noise Ratio, Frame Error Rate and Bit Error Rate.

29. The method of claim 26, wherein providing for substantially canceling the one or more interferers comprises providing for generating an interference matrix from the one or more interferers.

30. The method of claim 29, wherein providing for substantially canceling the one or more interferers further comprises providing for generating a cancellation operator from the interference matrix.

31. The method of claim 30, wherein providing for generating the cancellation operator comprises providing for generating a projection operator substantially according to the following form:
Pₛ^{⊥}I−S(S^{T}S)⁻¹S^{T},
where Pₛ^{⊥} is the projection operator, I is an identity matrix, S is an interference matrix and S^{T} is a transpose of S.

32. The method of claim 30, wherein providing for substantially canceling the one or more interferers further comprises providing for applying the cancellation operator to the signal to substantially cancel the one or more interferers from the signal.

33. The method of claim 31, wherein providing for substantially canceling the one or more interferers further comprises providing for applying the projection operator to the signal to substantially cancel the one or more interferers from the signal.

34. The method of claim 26, further comprising providing for combining a first processed signal of a first receiver chain and a second processed signal of a second receiver chain to improve processing of the signal, wherein the first and the second processed signals are correlated signals of a signal of interest.

35. The method of claim 34, wherein providing for combining the first processed signal and the second processed signal comprises providing for combining using a Maximal Ratio Combining algorithm or a Minimum Mean Squared Error algorithm.

36. The method of claim 26, further comprising providing for combining processed signals of processing fingers of at least one receiver chain to improve processing of the signal, wherein the processed signals are correlated signals of a signal of interest.

37. The method of claim 35, wherein providing for combining the processed signals comprises combining using a Maximal Ratio Combining algorithm or a Minimum Mean Squared Error algorithm.

38. A digital computer system programmed to perform the method of claim 26.

39. A computer-readable medium storing a computer program implementing the method of claim 26.

40. A receiver, comprising:
a plurality of receiver chains, wherein each receiver chain is configured for receiving a radio signal when directed by a controller and wherein each receiver chain comprises an analog to digital converter configured for converting a received radio signal to a digital signal; and
a processing engine communicatively coupled to each receiver chain and configured for substantially canceling one or more interfering signals from the digital signal of at least one receiver chain to generate an interference-canceled signal.

41. The receiver of claim 40, further comprising the controller, wherein the controller is configured for directing which of the receiver chains is to receive the radio signal.

42. The receiver of claim 41, wherein said at least one receiver chain comprises a plurality of processing fingers and wherein at least one processing finger of said at least one receiver chain is configured for processing the interference-canceled signal.

43. The receiver of claim 42, wherein the controller is further configured for combining processed signals from the processing fingers using a Maximal Ratio Combining algorithm or a Minimum Mean Squared Error algorithm.

44. The receiver of claim 41, wherein the controller is further configured for combining a first processed signal output from the first receiver chain and a second processed signal output from the second receiver chain to improve processing of the digital signal using a Maximal Ratio Combining algorithm or a Minimum Mean Squared Error algorithm, wherein the first and the second processed signals are digital representations of a correlated signal of interest received by the first and the second receiver chains.

45. The receiver of claim 40, wherein the processing engine comprises a matrix generator configured for generating an interference matrix from at least one of the one or more interfering signals of the digital signal.

46. The receiver of claim 45, wherein the processing engine comprises a processor configured for using the interference matrix to generate a cancellation operator.

47. The receiver of claim 46, wherein the cancellation operator is a projection operator substantially comprising the form:
Pₛ^{⊥}=I−S(S^{T}S)⁻¹S^{T},
where Pₛ^{⊥} is the projection operator, I is an identity matrix, S is the interference matrix and S^{T} is a transpose of S.

48. The receiver of claim 47, wherein the projection operator is configured for projecting a digital signal onto a subspace substantially orthogonal to the at least one of the one or more interfering signals.

49. The receiver of claim 46, wherein the processing engine comprises an applicator configured for applying the cancellation operator to the digital signal to generate an interference-canceled signal.

50. The receiver of claim 48, wherein the processing engine comprises an applicator configured for applying the projection operator to the digital signal to generate an interference-canceled signal.

51. The receiver of claim 40, wherein the plurality of receiver chains is adapted to receive a plurality of communications signals selected from a group consisting of Code Division Multiple Access signals, Wideband Code Division Multiple Access signals, Global Positioning System signals and Universal Mobile Telephone Service signals.

52. A receive-diversity system, comprising:
a plurality of receiver chains, wherein at least one receiver chain comprises a processing engine configured for substantially canceling one or more interferers from at least one radio signal received by said at least one receiver chain; and
a controller communicatively coupled to the plurality of receiver chains and configured for selecting one or more of the plurality of receiver chains to process the at least one radio signal.

53. The receive-diversity system of claim 52, wherein a received radio signal comprises a plurality of communication signals selected from a group consisting of Code Division Multiple Access signals, Wideband Code Division Multiple Access signals, Global Positioning System signals, and Universal Mobile Telephone Service signals.

54. The receive-diversity system of claim 52, wherein the at least one receiver chain comprises a plurality of processing fingers and wherein at least one processing finger of said at least one receiver chain is configured for processing an interference-canceled signal generated by the processing engine of the at least one receiver chain.

55. The receive-diversity system of claim 54, wherein the controller is configured for combining processed signals from the processing fingers.

56. The receive-diversity system of claim 52, wherein the controller is configured for combining a processed signal from each of the plurality of receiver chains.

57. The receive-diversity system of claim 52, wherein each of the plurality of receiver chains comprises an Analog to Digital converter configured for converting a received radio signal to a digital signal.

58. The receive-diversity system of claim 57, wherein the processing engine comprises a matrix generator configured for generating an interference matrix from at least one of the one or more interferers in the digital signal.

59. The receive-diversity system of claim 58, wherein the processing engine comprises a processor configured for using the interference matrix to generate a cancellation operator.

60. The receive-diversity system of claim 59, wherein the cancellation operator is a projection operator substantially comprising the form:
Pₛ^{⊥}=I−S(S^{T}S)⁻¹S^{T},
where Pₛ^{⊥} is the projection operator, I is an identity matrix, S is the interference matrix and S^{T} is a transpose of S.

61. The receive-diversity system of claim 60, wherein the projection operator is configured for projecting a digital signal onto a subspace substantially orthogonal to at least one interfering signal.

62. The receive-diversity system of claim 52, wherein the controller is further configured for comparing a signal parameter to a predetermined threshold to control a number of the plurality of receiver chains.

63. The receive-diversity system of claim 62, wherein the signal parameter is selected from a group consisting of Signal to Noise Ratio, Frame Error Rate, and Bit Error Rate.

64. A handset, comprising:
a plurality of receiver chains;
a controller communicatively coupled to the receiver chains and configured for selecting one or more of the receiver chains to process a received signal; and
a processing engine communicatively coupled to the receiver chains and configured for substantially canceling one or more interferers from the received signal.

65. The handset of claim 64, wherein the received signal comprises a plurality of communication signals selected from a group consisting of Code Division Multiple Access signals, Wideband Code Division Multiple Access signals, Global Positioning System signals, and Universal Mobile Telephone Service signals.

66. The handset of claim 64, wherein at least one receiver chain comprises a plurality of processing fingers and wherein at least one of the plurality of processing fingers is configured for processing an interference-canceled signal.

67. The handset of claim 66, wherein the controller is configured for combining processed signals from the plurality of processing fingers.

68. The handset of claim 64, wherein the controller is configured for combining a processed signal from each of the plurality of receiver chains.

69. The handset of claim 64, wherein the processing engine comprises a matrix generator configured for generating an interference matrix from at least one of the one or more interferers in a digital signal from one of the plurality of receiver chains.

70. The handset of claim 69, wherein the processing engine comprises a processor configured for generating a cancellation operator from the interference matrix.

71. The handset of claim 70, wherein the cancellation operator is a projection operator substantially comprising the form:
Pₛ^{⊥}=I−S(S^{T}S)⁻¹S^{T},
where Pₛ^{⊥} is the projection operator, I is an identity matrix, S is the interference matrix and S^{T} is a transpose of S.

72. The handset of claim 71, wherein the projection operator is configured for projecting a received signal onto a subspace substantially orthogonal to at least one interfering signal.

73. The handset of claim 64, wherein the controller is further configured for comparing a signal parameter to a predetermined threshold to control a number of the plurality of receiver chains.

74. The handset of claim 73, wherein the signal parameter is selected from a group consisting of Signal to Noise Ratio, Frame Error Rate, and Bit Error Rate.
